(19) United States
(12) Patent Application Publication
(10) Pub. No.: US 2007/0094614 A1
(43) Pub. Date: Apr. 26, 2007

(54) Data processing device

(76) Inventors: Masuo Kawamoto, Osaka (JP); Hideki Takeda, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,106

(22) Filed: Oct. 26, 2005

(51) Int. Cl. G06F 17/00

(52) U.S. Cl. 715/822; 715/856

(57) ABSTRACT

A cursor position determination unit 101 determines that a cursor 201 has been aligned, for instance, on an object 206 among a plurality of objects 202 to 209. Then, an object selection determination unit 105 receives selection instruction information indicating the selection of the object onto which the cursor 201 has been aligned, and determines that the object has been selected, while at the same time, an adjacent object determination unit 106determines an adjacent object, which is adjacent to the selection object. An object validation determination unit 107 does not accept validation instruction information about to be mistakenly input for the adjacent object, as the validation instruction information for the adjacent object.

### FIELD OF THE INVENTION

The present invention relates to an information processing device, such as a personal computer; in particular, it relates to an information processing device capable of displaying an object such as a file or a folder on a display screen in a window system.

### BACKGROUND INFORMATION

Conventionally, an information processing device, such as a personal computer (PC), is generally constituted in such a way that an object, such as a file or a folder, is displayed on a display screen in a window system, and is selected by pointing to it with a pointing device, such as a mouse, and specifically, by moving the cursor of the pointing device on the display screen, aligning it with the object (by placing the cursor over the object) and clicking at the position of this object. In such cases as those wherein the size (width) of the object is too small, when performing this selection, there has been a problem that the cursor misses the object, or that the cursor is aligned with an object that is different from the desired object, or the like, whereby alignment with the object is not performed well. To counter this, a technique has been disclosed in which, when the cursor approaches a button (corresponding to the object), this button is displayed enlarged, in order to facilitate the alignment.

However, with such prior art, although an object can be displayed enlarged for selection, a problem still remains that, for instance, in such cases as those wherein an operation must be carried out quickly, when selecting an object by a predetermined selection action (for instance by a click action) and then validating this object by a further predetermined validation action (for instance by a double-click action), if the validation action (the above double-click action) is carried out mistakenly on an object that is at an adjacent position to the object, it is this mistaken object that becomes selected or validated.

The present invention was devised in view of the above problem, and an object thereof is to provide an information processing device that allows selection and validation of a desired object to be reliably carried out without mistakenly selecting or validating an object present at an adjacent position to the object to be validated by pointing, and consequently allows operability during pointing operations to be increased.

### SUMMARY OF THE INVENTION

The information processing device according to the present invention comprises: a display means for displaying a plurality of objects and a pointing device cursor; a position determination means for determining whether the cursor is aligned onto one object among the plurality of objects; a selection determination means for receiving selection instruction information indicating that the object onto which the cursor is aligned is selected and for determining that the object has been selected; a validation determination means for determining that the selection object has been validated as a result of receiving validation instruction information indicating that the selected selection object is to be validated; and an adjacency determination means for determining an adjacent object, which is an object that is adjacent to the selection object, the validation determination means not accepting the validation instruction information for the adjacent object, which the adjacency determination means has determined, as a validation instruction information for the adjacent object.

According to the above constitution, a position determination means determines that a cursor has been aligned over one object among a plurality of objects. Then, upon receipt of selection instruction information indicating the selection of the object with which the cursor has been aligned, the selection determination means determines that the object has been selected, and an adjacent object, which is adjacent to this object, is determined by the adjacency determination means. The validation instruction information for this adjacent object (that is to say, the validation instruction information which would have been input for the adjacent object) is not accepted by the validation determination means as validation instruction information for the adjacent object.

In addition, it is preferred that the validation determination means accept the validation instruction information for the adjacent object, which the adjacency determination means has determined, as the validation instruction information for the selection object. In this way, the validation instruction information for the adjacent object is accepted as the validation instruction information for the selection object by the validation determination means.

In addition, it is preferred that the device further comprise an enlargement means for displaying the object enlarged, onto which the cursor is aligned, and a displacement means for displacing in a predetermined direction some or all of the objects other than the enlarged object that is displayed enlarged among the plurality of objects, in order to prevent those objects from becoming hidden behind the enlarged object.

In this way, when a given object is displayed enlarged, some or all of the remaining objects are displaced in a predetermined direction so as not to become hidden behind the enlarged object.

In addition, it is preferred that the device further comprise a region enlargement means for enlarging an input region for instruction input for the selection instruction information and the validation instruction information, from the size of the object prior to enlargement to the size of the enlarged object, concomitantly to the enlargement of the object by the enlargement means. In this way, the input region also enlarges concomitantly to the enlargement of the object.

Furthermore, it is preferred that the device further comprise an acquisition means for acquiring object information regarding the enlarged object, the display means displaying the acquired object information. In this way, object information regarding the enlarged object is displayed by the display means.

According to the invention of claim 1, as the constitution is such that the validation instruction information for an adjacent object is not accepted by the validation determination means as validation instruction information for the adjacent object, selection and validation of the desired object can be performed more reliably without mistakenly selecting or validating an object present in an adjacent position to the object (selection object) that is to be validated after pointing (after aligning the cursor over the desired object and clicking for selection, or the like), which allows operability to be improved for pointing operations.

According to the invention recited in claim 2, as the constitution is such that the validation instruction information for the adjacent object is accepted by the validation determination means as the validation instruction information for the selection object, it is also possible to input validation instruction information for the selection object from an object present at an adjacent position to the object to be validated (selection object), allowing selection and validation of the desired object to be performed more easily and more reliably.

According to the invention recited in claim 3, as the object onto which the cursor has been aligned becomes enlarged, it is easy to see which object is the one with which the cursor is aligned, that is to say, the visibility increases, allowing selection of an object to be performed reliably. In addition, this can prevent other objects, which are objects other than this enlarged object, from becoming hidden therebehind, so as to avoid situations such as those wherein the other objects cannot be seen by the user, or wherein the cursor cannot be on the other objects.

According to the invention recited in claim 4, as the input region is enlarged concomitantly to the object enlargement, instruction input from the input region for the selection instruction information or the validation instruction information can be performed more reliably.

According to the invention recited in claim 5, as the information regarding the enlarged object is displayed by the display means, assessment information can be provided to the user when selecting or validating the enlarged object, so as to better prevent errors in object selection or validation.

### BRIEF DESCRIPTION OF THE DRAWINGS

FIG. 1 is a block diagram schematically illustrating the constitution of a PC, which is one example of an information processing device according to an embodiment of the present invention.

FIG. 2 is a view showing an example of display screen during object selection and validation.

FIG. 3 is an enlarged view of a portion of the display screen in FIG. 2.

FIG. 4 is a flowchart showing an example of operation for a case where validation instruction information has been mistakenly entered for an adjacent object.

### DETAILED DESCRIPTION OF THE PREFERRED EMBODIMENTS

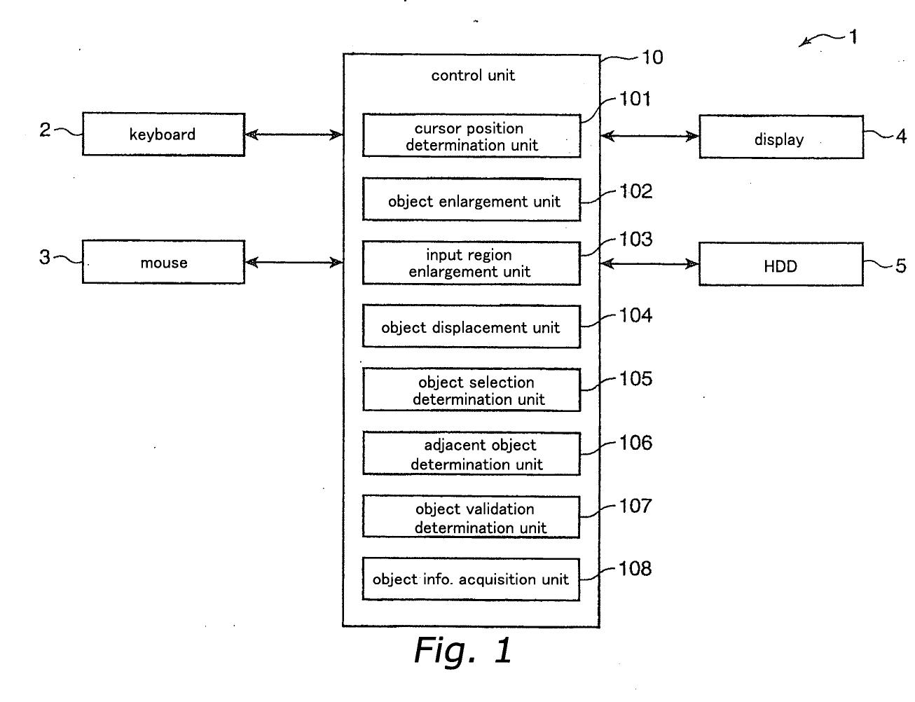

FIG. 1 is a block diagram schematically illustrating the constitution of a PC, which is one example of an information processing device according to an embodiment of the present invention. The PC (personal computer) 1 comprises a control unit 10 inside the device main body, which governs the operational control for the entire device. The control unit 10 consists of a ROM (Read Only Memory) that stores a control program (OS program) or the like for the PC 1, and a RAM (Random Access Memory) that stores data temporarily, a CPU that reads the control program or the like from the ROM and executes it, and the like, and controls the entire device in response to predetermined instruction information entered by way of a keyboard 2, a mouse 3 or the like described below, or to a detection signal from various sensors provided at various locations in the present device. The keyboard 2, the mouse 3, a display 4, an HDD (Hard Disk Drive) 5 and the like are connected to the control unit 10. The keyboard 2 consists of various key groups, such as alphanumeric keys, for performing input of various instruction information by the user. The mouse 3 is a so-called pointing device, which moves a cursor displayed on the display screen described below, concomitantly to the movement of the mouse 3 (the rotation of the ball underneath the mouse 3), or enters predetermined instruction information by a click action such as a single click or a double click. Hereinafter, where appropriate, a single click will be expressed simply as a click. The display 4, which consists of a CRT (Cathode Ray Tube) monitor or an LCD (Liquid Crystal Display) monitor, is a display device for displaying a predetermined screen (image), and displays a window (a window screen) in a window system, or displays a plurality of objects such as files and folders, and the cursor for the mouse 3 or the like. The HDD 5 is a storage device where various data, such as programs for various application software running on the window system, image data and sound data, are stored.

The control unit 10 comprises a cursor position determination unit 101, an object enlargement unit 102, an input region enlargement unit 103, an object displacement unit 104, an object selection determination unit 105, adjacent object determination unit 106, object validation determination unit 107 and an object information acquisition unit 108. The cursor position determination unit 101 determines the position (coordinate position) of the cursor on the screen (display screen) of the display 4, while at the same time, it determines whether the cursor is aligned on an object among a plurality of objects displayed on the display screen, that is to say, which object among the plurality of objects is pointed to by the cursor.

The object enlargement unit 102 displays the object on which the cursor is aligned, enlarged on the display 4 (on the display screen). Note that, the enlargement of the object may be performed based on a preset enlargement factor. In this case, for instance, the constitution is such as to enlarge the object, for instance, to twice the original object size (for instance, doubling each measurement).

The input region enlargement unit 103 enlarges the input region for instruction input of selection instruction information, for instance, by a click of the mouse 3, and validation instruction information, for instance, by a double click, concomitantly to the enlargement of the object (hereinafter, the object that has been enlarged is referred to as enlarged object) by the object enlargement unit 102, from the size of the object prior to the enlargement to the size of the enlarged object. In this way, input of selection instruction information and validation instruction information becomes possible from any position on the enlarged object.

In order to prevent other objects, which are objects other than the enlarged object that is displayed enlarged among the plurality of objects, from becoming hidden behind the enlarged object, the object displacement unit 104 displaces some or all of the other objects in a predetermined direction on the display screen, for instance in the vertical, horizontal or diagonal direction (the positions of the other objects are shifted).

The object selection determination unit 105 receives the selection instruction information that indicates the selection of the object onto which the cursor is aligned, and determines that the object has been selected. The object that has been selected is hereinafter referred to as the selection object. The selection of the object onto which the cursor has been aligned is performed, for instance, by aligning the cursor on an object, and for instance, clicking over this object. The object selection determination unit 105 may have a constitution that displays the color of the selection object by changing (switching) it to a different color from the background color (for instance, the color of the window where the selection object is displayed). In this way, validation of the selected object becomes easy, preventing errors in object selection.

The adjacent object determination unit 106 determines, among a plurality of objects, an adjacent object, which is an object that is adjacent to the selection object. The adjacent object may be an object that is adjacent to the enlarged object in any direction, such as the vertical, horizontal, or diagonal direction.

The object validation determination unit 107 receives validation instruction information indicating that the selection object is to be validated and determines that the selection object has been validated. To validate the selection object means, for instance, to make a definitive validation of the selection object that was selected by a click as described above, with the object of executing a predetermined process; and when validated, this validated object opens as a window (for instance, if the object is a file), or application software corresponding to the object starts up (for instance, if the object is a startup icon (shortcut icon) for an application).

The object validation determination unit 107 does not accept the validation instruction information for the adjacent object determined by the adjacent object determination unit 106, as the validation instruction information for the adjacent object, but accepts it as the validation instruction information for the selection object. In other words, the object validation determination unit 107 enlarges the input region for the selection object by extending it to the objects that are adjacent to the selection object.

Specifically, even if, when intending to validate the selection object by performing, for instance, a double click on the selection object (enlarged object), an adjacent object with respect to the selection object is double-clicked, the object validation determination unit 107 does not accept (does not handle) the validation instruction information by the double click on the adjacent object as the validation instruction information for the adjacent object, but accepts (handles) it as the validation instruction information for the selection object. That is to say, the object validation determination unit 107 determines that the validation instruction information by the double click on the adjacent object is the validation instruction information for the selection object.

The object information acquisition unit 108 acquires object information regarding the enlarged object while at the same time causing the display 4 to display this object information. Specifically, the object information acquisition unit 108 causes, almost simultaneously to cursor alignment onto an object the object information for the enlarged object which the cursor has been aligned onto, for instance, file information, when the enlarged object is a file, such as the file size, the update date and time and the file content, to be displayed at a predetermined position (region) on the display screen, for instance, at an edge position inside the same window as that where the enlarged object is displayed. Note that, the above object information may be assigned to each object and, for instance, stored in the HDD 5, or stored in the object information acquisition unit 108 itself or in the control unit 10.

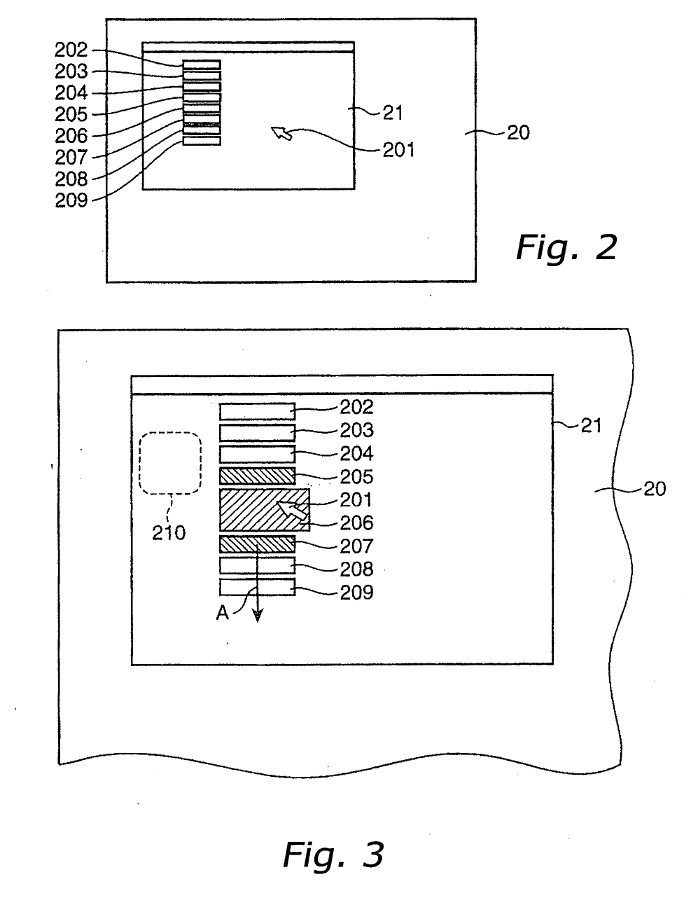

Here, the action of selection and validation of the object displayed on the display screen will be explained. FIG. 2 is a view showing an example of a display screen during object selection and validation, and FIG. 3 is an enlarged view of a portion of the display screen in FIG. 2. First, it is assumed that a window 21 and a cursor 201 of the mouse 3 are displayed on a display screen 20, and that a plurality of objects 202 to 209 (specifically, these may be files, with information relative to each file, such as an icon and the file name noted together), are displayed inside this window 21, as shown in FIG. 2. When this cursor 201 is moved over the display screen 20 in response to the operation of the mouse 3 and the cursor 201 is aligned with respect to the objects 202 to 209, the object aligned onto is displayed enlarged, while at the same time, information on the aligned object is displayed, for instance, in a display region indicated with a reference numeral 210 (an object information display region 210); in addition, the input region is also enlarged in accordance with the enlarged display of this object.

When the cursor 201 is moved to a desired object (here, object 206 is assumed) among these objects 202 to 209, clicking in this state, so as to input selection instruction information, selects the object 206 displayed enlarged, while at the same time, the objects 207 to 209 positioned below this object 206 are displaced in the direction of the arrow indicated as A (downward direction) so as not to be hidden behind the object 206, which has been enlarged, as shown in FIG. 3. Note that, in this case, displacement in the upward direction is difficult because the edge of the window 21 is located above the object 202, thus the displacement of the objects 207 to 209 is performed in the downward direction. If displacement in the upward direction is possible, the objects 202 to 205 may be displaced in the upward direction (displacement of the object 202 to 205 in the upward direction and the displacement of the object 207 to 209 in the downward direction may also be carried out simultaneously). Note that, when the object 206 is selected, the color of the object 206 changes to a color that is different from the background color of the window 21. In addition, when the input region is enlarged, it is enlarged, for instance, from the size of the object 206 prior to the enlargement as shown in Fig. 2 (here, the vertical and horizontal dimensions of the object 202 shown in FIG. 2) to the size of the enlarged object 206 shown in FIG. 3.

When the object 206 is selected, the object 205 and the object 207 are determined to be adjacent objects to this selected object 206. In order to validate this selected object 206, the user aligns the cursor. 201 onto the object 206, and attempts to double-click so as to input validation instruction information, but the user may sometimes displace (aligns) the cursor 201 mistakenly onto the object 205 or the object 207, and double-click in this state; however, in this case, the input (validation instruction information) resulting from the double click on the object 205 or 207 is not accepted as an input for the object 205 or 207, but rather is accepted as an input for the object 206. This allows the object 206 to be the object to be validated, even if the adjacent object 205 or 207 is double-clicked as the result of an operational mistake.

Note that, selection of the object 205 (207) is possible from the state shown in FIG. 3 where the object 206 is selected, by single-clicking on the object 205 (207) without carrying out validation of the object 206 (without performing double-clicking on the object 206, or the adjacent objects 205 or 207). In this case, the object 205 (207) is displayed enlarged and the color changes, while at the same time, some or all of the objects other than the object 205 (207) are displaced. It goes without saying that a similar selection action for objects other than the objects 205 and 207 is possible.

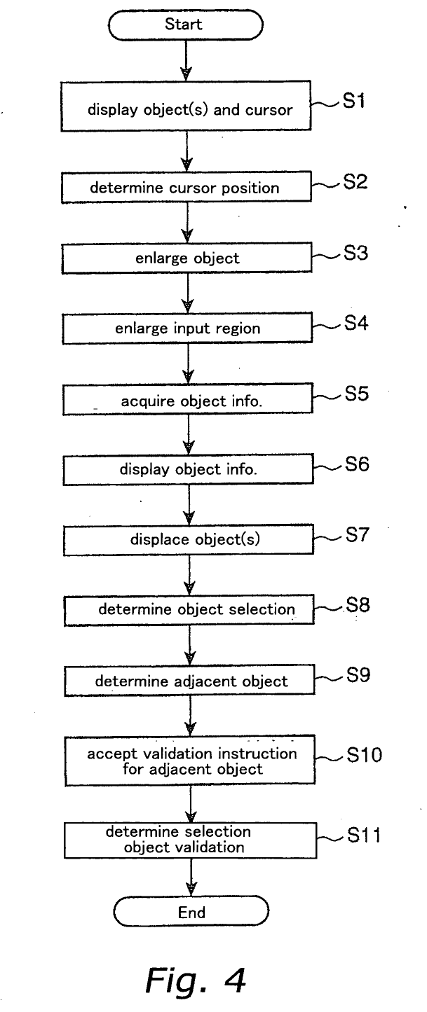

FIG. 4 is a flowchart showing an exemplary operation for a case in which validation instruction information has been mistakenly entered for the adjacent object. First, a plurality of objects (for instance, objects 202 to 209) and a cursor 201 are displayed (step S1) on the display 4 (display screen 20). The position (coordinate position) of the cursor 201 on the display screen 20 is determined, while at the same time, the cursor position determination unit 101 determines on which of the plurality of objects the cursor 201 is aligned (step S2). Next, the object onto which the cursor 201 has been aligned is enlarged (step S3), and the input region enlargement unit 103 enlarges the input region according to the enlargement of the object mentioned above in step S3 (step S4). Then, object information regarding the enlarged object is acquired, for instance, from the HDD 5 by the object information acquisition unit 108 (step S5), and the object information is displayed on the display 4 (for instance, the object information display region 210 of the display screen 20) (step S6). Some or all of the other objects, which are other than the enlarged object, are displaced in a predetermined direction by the object displacement unit 104 (step S7).

The object selection determination unit 105 receives selection instruction information by way of a click, indicating the selection of the object onto which the cursor 201 has been aligned (for instance, the object 206), and determines that the object has been selected (step S8), and adjacent objects, which are adjacent to this object (for instance, objects 205 and 207) are determined by the adjacent object determination unit 106 (step S9). Then, the object validation determination unit 107 does not accept validation instruction information for the adjacent object (for instance, the object 205 or 207) as the validation instruction information for this adjacent object, but accepts it as validation instruction information for the selection object (the object 206) (step S10), and the object validation determination unit 107 determines that the selection object has been validated (step S11).

As described above, according to the information processing device of the present invention, as the constitution is such that the object validation determination unit 107 does not accept the validation instruction information for the adjacent object as validation instruction information for this adjacent object, the selection and validation of the desired object (for instance, object 206) can be carried out more reliably, without mistakenly selecting or validating an adjacent object (for instance, object 205 or 207) present in an adjacent position to the selection object to be validated (for instance, object 206) after pointing (after selecting the desired object by aligning the cursor 201 thereto and clicking and the like), and consequently it is possible to improve operability during pointing operation.

In addition, as the constitution is such that the object validation determination unit 107 accepts the validation instruction information for the adjacent object as the validation instruction information for the selection object, validation instruction information can also be input for the selection object from the adjacent object (for instance, object 205 or 207) present in an adjacent position to the selection object to be validated (for instance, object 206), allowing the selection and validation of the desired object (object 206) to be carried out more easily and reliably.

In addition, as the object onto which the cursor 201 has been aligned (for instance, the object 206) is enlarged, it is easier to see which of the objects the cursor is aligned on, which is to say, visibility is improved, allowing object selection to be carried out reliably. In addition, display wherein objects (objects 202 to 205 and objects 207 to 209) other than the enlarged object (for instance, the object 206) are hidden behind this enlarged object can be prevented, allowing each object to be displayed on the display screen 20 (window 21) without preventing the user from seeing the other objects, or preventing the users from aligning the cursor 201 onto the other objects.

In addition, as the input region is enlarged concomitantly to the enlargement of the object, input of the selection instruction information or the validation instruction information from the input region is performed more reliably. Furthermore, as information regarding the enlarged object (for instance, object 206) is displayed on the display screen 20 (window 21), assessment information can be provided to the user when selecting or validating the enlarged object, preventing an object from being mistakenly selected or validated. In addition, the present invention may adopt the following aspects:

(A) The present invention comprises a display unit not limited to the PC 1, where an object or the like is displayed, and is applicable to any device as long as it is an information processing device performing selection and validation of objects.

(B) In place of the mouse 3, a trackball, a touch pad provided on a notebook PC or the like may be used as the pointing device.

(C) The displacement of the cursor on the display screen need not be performed by a displacement operation with a mouse, and may be performed, for instance, by vertically and horizontally operating displacement keys or the like on a keyboard.

(D) The constitution may be such that the enlarged display of the object is performed at the time point when the object is selected (at the time point when the cursor is aligned on an object and this object is further single-clicked).

What is claimed is:

1. An information processing device comprising:
a display means for displaying a plurality of objects and a pointing device cursor;
a position determination means for determining whether the cursor is aligned onto one object among the plurality of objects;
a selection determination means for receiving selection instruction information indicating that the object onto which the cursor is aligned is selected and for determining that the object has been selected;
a validation determination means for determining that the selection object has been validated as a result of receiving validation instruction information indicating that the selected selection object is to be validated; and
an adjacency determination means for determining an adjacent object, which is an object that is adjacent to the selection object,
the validation determination means not accepting the validation instruction information for the adjacent object, which the adjacency determination means has determined, as a validation instruction information for the adjacent object.

2. The information processing device as recited in claim 1, wherein the validation determination means accepts the validation instruction information for the adjacent object, which the adjacency determination means has determined, as the validation instruction information for the selection object.

3. The information processing device as recited in claim 1 further comprising: an enlargement means for displaying the object enlarged, onto which the cursor is aligned; and
a displacement means for, in order to prevent other objects, which are objects other than the enlarged object that is displayed enlarged among the plurality of objects, from becoming hidden behind the enlarged object, by displacing in a predetermined direction some or all of the other objects.

4. The information processing device as recited in claim 3 further comprising a region enlargement means for enlarging an input region for instruction input for the selection instruction information and the validation instruction information, from the size of the object prior to enlargement to the size of the enlarged object, concomitantly to the enlargement of the object by the enlargement means.

5. The information processing device as recited in claim 3 further comprising an acquisition means for acquiring object information regarding the enlarged object,
the display means displaying the acquired object information.
